(19) United States
(12) Patent Application Publication
(10) Pub. No.: US 2010/0199918 A1
(43) Pub. Date: Aug. 12, 2010

(54) SYSTEM AND METHOD FOR AUTOMATICALLY DEACTIVATING A POULTRY WATERING DEVICE

(76) Inventors: Thomas K. Reusche, Elburn, IL (US); Philip E. Chumbley, Aurora, IL (US)

Correspondence Address: MCANDREWS HELD & MALLOY, LTD, 500 WEST MADISON STREET, SUITE 3400, CHICAGO, IL, 60661, US

(21) Appl. No.: 12/695,769

(22) Filed: Jan. 28, 2010

Related U.S. Application Data
(60) Provisional application No. 61/151,044, filed on Feb. 9, 2009.

(51) Int. Cl. A01K 7/02; F03B 11/02

(52) U.S. Cl. 119/74; 137/1; 137/561 R

(57) ABSTRACT

Certain embodiments of the present invention provide a watering system configured to provide water to livestock. The system may include a water basin, a reservoir, a biasing mechanism and a cap. The water basin defines a trough configured to retain water. A water path having an inlet and outlet is formed through a portion of the water basin. The reservoir is mounted to the water basin. The biasing mechanism is configured to selectively open and close the inlet. The cap is removably secured to the reservoir and configured to selectively engage the biasing mechanism to open and close the inlet. The cap remains connected to the reservoir and the biasing mechanism when the inlet is open.

### RELATED APPLICATIONS

The present application relates to and claims priority from U.S. Provisional Application No. 61/151,044, entitled “System and Method for Automatically Deactivating a Poultry Watering Device,” filed Feb. 9, 2009, which is hereby incorporated by reference in its entirety.

### FIELD OF THE INVENTION

Embodiments of the present invention generally relate to a system and method for providing water to livestock, such as poultry, and more particularly, to a system and method for automatically deactivating a watering device so that it may be re-filled with water.

### BACKGROUND OF THE INVENTION

Gravity-feed watering devices have been used for a number of years in order to provide water for livestock, such as chickens, to drink. In general, the watering device includes a basin having a low wall that defines a drinking trough. A metal or plastic water reservoir is mounted above the basin. Typically, the reservoir has a fluid capacity of one to five gallons.

In use, the reservoir is positioned on the basin such that an open end is downwardly-oriented, akin to a bucket that is turned upside down. In order to fill the watering device, the reservoir is detached from the basin. The reservoir is then inverted so that its open end is exposed. Water may then be filled into the reservoir, which then retains the water. After the reservoir is filled, the basin is reattached to the reservoir, and the device is tipped over, such that the basin is upwardly-oriented and the reservoir is downwardly-oriented. In this orientation, the outer circumferential wall of the basin overhangs the reservoir, as the diameter of the basin exceeds that of the reservoir.

FIG. 1 illustrates a cross-sectional view of a conventional watering device 10. The device 10 includes a basin 12 having base 14 integrally formed with an outer wall 16 defining a water-retaining volume therebetween. The device 10 also includes a reservoir 18 having a base 20 integrally formed with circumferential walls 22. An open end of the reservoir leads to a cavity 24 configured to receive and retain water 26.

As shown in FIG. 1, the device 10 is in an operational configuration such that the reservoir 18 is attached to the basin 12. As noted above, the outer wall 16 of the basin 10 overhangs an outer circumference of the reservoir 18.

The edges of the walls 22 of the reservoir 18 attach to the basin 12 at a level that is lower than the upper edges of the outer wall 16 of the basin 12. Accordingly, a drinking trough 28 is defined between the outer wall 16 and the edges of the walls 22.

A channel or notch may be formed proximate the edge of walls 22 of the reservoir 18. The channel allows water to flow by force of gravity from the reservoir 18 into the trough 28. As water flows out of the reservoir 18, it is replaced by air that bubbles past the edge and collects in an air pocket 29 above the water 26 contained within the reservoir 18.

As the water level in the trough 28 rises, however, the edge of the reservoir 18 becomes submerged, and backward flow of air into the reservoir 18 stops. At this point, water continues to flow, thereby expanding the volume of the air pocket 29 trapped inside the reservoir 18. However, because air is no longer flowing into the volume of the air pocket 29, air pressure therein decreases. Water continues to flow from the reservoir 18 into the trough 28 until the weight of the water 26 inside the reservoir plus the pressure of the trapped air 29 is balanced by ambient air pressure outside the reservoir 18.

As noted above, in order for the reservoir 18 to be filled, the reservoir 18 must be inverted such that the base 20 rests on a surface. Attempting to reattach the basin 12 to the reservoir 18 while the reservoir 18 is in this position usually results in water being spilled when the device 10 is reoriented into its operational position.

To alleviate this drawback, some devices include a reservoir having an opening in the base that is covered by a fluid-tight cap. In order to keep the water from exiting the reservoir and overflowing the drinking trough during the filling process, however, the water path leading from the reservoir to the trough must be closed. Some devices include a small cap that is configured to be manually rotated. The cap rotatably engages the nozzle leading from the reservoir to the trough. With such a device, a user needs to unscrew the small cap from its storage spot, then manipulate it such that the user's fingers are in the drinking water, and screw the cap onto the bottom nozzle, thereby closing off the water path. After filling, the cap is removed and replaced on the reservoir. As can be appreciated, this type of device provides an awkward and time-consuming filling process.

Other devices include spring-loaded valves on the inner walls of a double-walled reservoir. The valves move forward to close the water path when an outer shroud of the reservoir is removed. With these devices, extra material and weight is required to provide the double-walled reservoir. The inner wall serves as a container with an open top to hold the water while the outer, removable shroud is in the form of a bucket turned upside down and covers the inner container, thereby forming an air seal. As such, the double-walled construction adds cost and material to the manufacturing process.

### SUMMARY OF THE INVENTION

Certain embodiments of the present invention provide a watering system configured to provide water to livestock. The system may include a water basin, a reservoir, a biasing mechanism, and a cap.

The water basin defines a trough configured to retain water. A water path having an inlet and outlet is formed through a portion of the water basin. The outlet leads to the trough.

The reservoir is mounted to the water basin. The reservoir may be removably secured to the water basin. Alternatively, the reservoir may be integrally formed with, and permanently fixed to, the basin.

The biasing mechanism is configured to selectively open and close the inlet.

The cap is removably secured to the reservoir and is configured to selectively engage the biasing mechanism to open and close the inlet. The cap remains connected to the reservoir and the biasing mechanism when the inlet is open. The cap is configured to be removed in order to fill the reservoir.

The reservoir may include an inwardly-canted top wall integrally connected to upstanding walls supported by the water basin. The cap is removably secured within an opening formed in the top wall.

In certain embodiments, the biasing mechanism may include a rod having first and second ends. The first end abuts into a portion of the cap, and the second end includes a plug that is configured to sealingly seat into the inlet.

The biasing mechanism may also include a biasing spring around at least a portion of the rod. The biasing spring is configured to be compressively sandwiched between the cap and a portion of the reservoir.

The rod may be flexible. Further, the rod may be contained within a tube.

In certain embodiments, the biasing mechanism includes a lever having first and second ends. The first end is proximate the cap and the second end connects to a proximal end of a rod. A stop cock proximate the inlet is connected to a distal end of the rod.

In certain embodiments, the cap includes a cone and the biasing mechanism includes a rod movably secured within a cage support. A first end of the rod abuts the cone and a second end of the rod contacts a pivotal cover over the inlet.

In certain embodiments, the biasing mechanism includes a rotatable rod comprising a tab at a first end and a rotatable plug at a second end. The rotatable plug is positioned within the water path. The cap includes a slot configured to receive and retain the tab. Rotation of the cap causes a responsive rotation in the rotatable plug when the tab is retained within the slot.

The rotatable plug may include a side wall having an opening that is configured to be rotated into alignment with the outlet. Optionally, the rotatable plug may include a disk having an opening that is configured to be rotated into alignment with the outlet.

Certain embodiments of the present invention provide a method of re-filling a watering system configured to provide water to livestock. The method includes disconnecting a cap positioned on a reservoir from a biasing mechanism that closes a water path within a water basin, opening the water path through the disconnecting, wherein the opening comprises removing the biasing mechanism from a plugging relationship within the water path when the cap is disconnected from the biasing mechanism, and opening a water intake of the reservoir through the disconnecting.

The disconnecting may include rotating the cap with respect to the reservoir. Optionally, the disconnecting may include lifting the cap away from the reservoir.

The opening the water path through the disconnecting may include biasing a plug connected to a rod into a water inlet of the water path.

Optionally, the disconnecting may include removing a stop cock from an inlet of the water path through pivotal movement of a lever connected to a rod having the stop cock at a distal end.

The disconnecting may include disconnecting a cone from a first end of a rod, wherein the disconnecting a cone causes a second end of the rod to move a cover over an inlet of the water path.

### BRIEF DESCRIPTION OF SEVERAL VIEWS OF THE DRAWINGS

FIG. 1 illustrates a cross-sectional view of a conventional watering device.

FIG. 2 illustrates a cross-sectional view of a watering system, according to an embodiment of the present invention.

FIG. 3 illustrates a cross-sectional view of a watering system, according to an embodiment of the present invention.

FIG. 4 illustrates a cross-sectional view of a watering system, according to an embodiment of the present invention.

FIG. 5 illustrates a cross-sectional view of a watering system, according to an embodiment of the present invention.

FIG. 6 illustrates a cross-sectional view of a selective water gate, according to an embodiment of the present invention.

FIG. 7 illustrates a cross-sectional view of a watering system, according to an embodiment of the present invention.

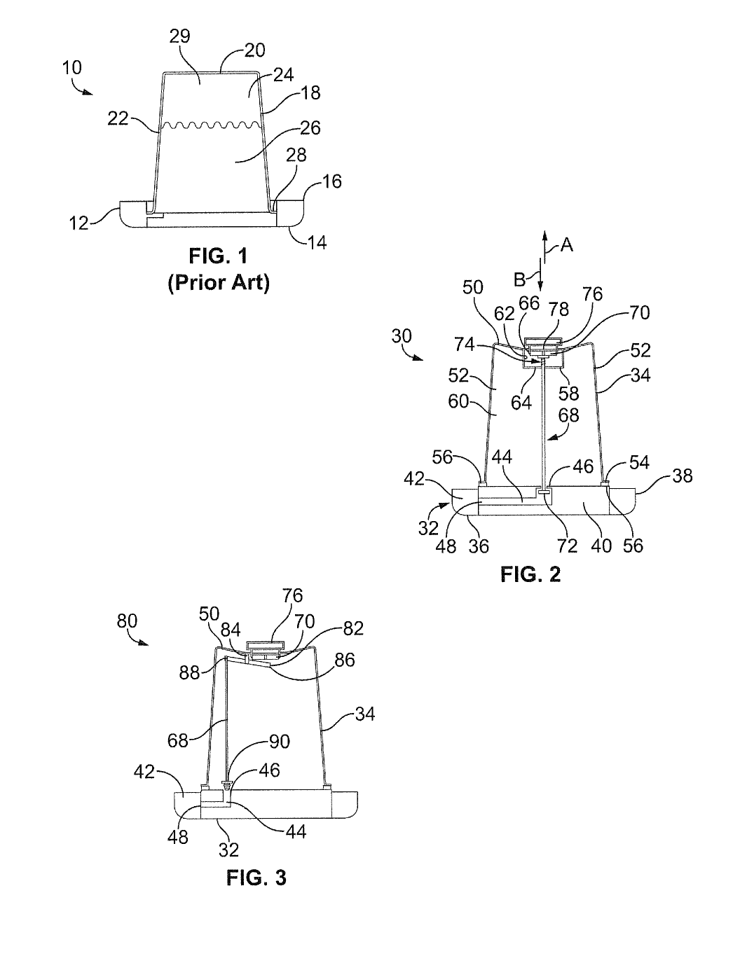

The foregoing summary, as well as the following detailed description of certain embodiments of the present invention, will be better understood when read in conjunction with the appended drawings. For the purpose of illustrating the invention, there are shown in the drawings, certain embodiments. It should be understood, however, that the present invention is not limited to the arrangements and instrumentalities shown in the attached drawings.

### DETAILED DESCRIPTION OF THE INVENTION

FIG. 2 illustrates a cross-sectional view of a watering system 30, according to an embodiment of the present invention. The system 30 includes a basin 32 and a reservoir 34, both of which may be circular in axial cross section. As shown, the reservoir 34 is a simple, single-wall construction that mounts above the upper edges of the walls of the basin 32. That is, the lowest edges of the reservoir 34 may be above the upper edges of the basin 32.

The basin 32 includes a base 36 integrally formed with upstanding circumferential walls 38. A central island 40 extends upwardly from the base 36 about a central axis of the basin 32. An annular drinking trough 42 surrounds the island 40. That is, the drinking trough 42 is defined between the walls 38 and the outer lateral surfaces of the island 40.

A water path 44 is formed through the island 40. The water path 44 includes an inlet 46 on top of the island 40. The inlet 46 connects to an outlet 48 on the side of the island 40. Thus, water may pass from the inlet 46 to the outlet 48, where it flows into the trough 42.

The reservoir 34 includes an inwardly-dented base or top wall 50 that integrally connects to circumferential walls 52. The base 50 cants downwardly toward a center thereof. The downward canting facilitates water draining into an opening formed through a center of the base 50.

The reservoir 34 is mounted on top of the island 40. Distal edges 54 of the walls 52 secure over the island 40 with a sealing gasket 56 therebetween.

The base 50 of the reservoir 34 includes a central chamber 58 extending from lower surfaces of the base 50 into the water-retaining cavity 60. The chamber 58 is defined by vertical walls 62 extending downwardly from the base 50. The vertical walls 62 integrally connect to a horizontal wall 64 having a passage formed therethrough. The vertical and horizontal walls 62 and 64 may include openings that allow water to pass therethrough. Optionally, the walls 62 and 64 may be beams, straps, or the like.

An opening 66 is formed through a center of the base 50 and leads into the central chamber 58. Exposed edges of the base 50 that define the opening 66 may be threaded.

A rod 68 connects to, or abuts into, a post 70 within the central chamber 58. The rod 68 passes through the opening formed through the horizontal wall 64 and extends through the inlet 46 of the water path 44 formed in the island 40. The rod 68 may be formed of metal or stiff plastic.

A plug 72 is positioned at a distal end of the rod 68. The plug 72 has a diameter that is greater than that of the inlet 46. Accordingly, the plug 72 cannot pass upwardly through the inlet 46.

A coil spring 74 surrounds the portion of the rod 68 within the central chamber 58. The spring 74 is compressively sandwiched between the horizontal wall 64 and a lower surface of the post 70. As such, the spring 74 exerts a force into the post 70 in the direction of arrow A, and a force into the horizontal wall 64 in the direction of arrow B.

A cap 76 having an air-tight seal 78 threadably secures to the base 50 over the opening 66. The post 70 may be part of the cap 76 (i.e., a central post extending downwardly from the cap 76, with the seal 78 surrounding an outer circumference of the post 70). The cap 76 may include a column, post (such as the post 70), shaft or the like that is threaded. Accordingly, the cap 76 threadably engages the exposed edges of the base 50. Optionally, the cap 76 may simply plug the opening 66 by way of the seal 78, which sealingly engages portions of the base 50 that define the opening 66.

In the operational configuration, as shown in FIG. 2, the cap 76 is secured to the base 50. In this position, the cap 76 forces the post 70 downward in the direction of arrow B. The seal 78 sealingly engages the exposed edges of the base, thereby forming a fluid tight seal. Accordingly, air is prevented from passing into the reservoir 34.

As the post 70 is forced downward in the direction of arrow B, the attached rod 68 also is forced in the same direction such that the plug 72 is unseated from the inlet 46 of the water path 44. Accordingly, water within the reservoir 34 may pass into the water path 44, and into the trough 42.

In order to fill the reservoir 34, instead of removing the reservoir 34 from the basin 32, the cap 76 is simply removed. As the cap 76 is removed from the base 50, the spring 74 forces the post 70 upward in the direction of arrow A. Accordingly, the rod 68 moves in response until the plug 72 seats against the inlet 46. Because the diameter of the plug 72 exceeds the diameter of the inlet 46, the plug 72 is prevented from ejecting through the inlet 46. The plug 72 may be formed of a fluid-tight material such as rubber. Therefore, when the plug 72 seats against the inlet 46, water is prevented from passing from the reservoir 34 into the water path 44. Thus, the trough 42 does not overflow during the filling process.

When the cap 76 is removed from the base 50 of the reservoir 34, water may be poured into the reservoir 34 through the opening 66. As noted, the water is prevented from passing into the water path 44 by the plug 72. Once the reservoir 34 is filled, the cap 76 is manipulated back into the opening 66. As the cap 76 is re-positioned back on the base 50, the cap 72 forces the post 70 downward in the direction of arrow B. Consequently, the rod 68 moves in response, and the plug 72 unseats from the inlet 46, thereby allowing water to pass from the reservoir 34 into the trough 42.

As shown and described, the rod 68 and cap 76 are part of a biasing mechanism that selectively opens and closes the inlet 46 based on whether the cap 76 is secured to, or removed from, the reservoir 34. That is, the biasing mechanism opens the inlet 46 when the cap 76 is secured to the opening 66 formed through the base 50 of the reservoir, and closes the inlet 46 when the cap 76 is removed from the reservoir 34.

The seal 78 ensures that air does not pass into the reservoir 34. Therefore, the system 30 operates to fill the trough 42 through a gravity-feed process, as intended.

FIG. 3 illustrates a cross-sectional view of a watering system 80, according to an embodiment of the present invention. The watering system 80 is similar to the system 30, except that the biasing mechanism includes a lever 82 pivotally secured to an underside of the base 50 through a beam 84. A proximal end 86 of the lever 82 is positioned underneath the post 70, while a distal end 88 of the lever 82 is connected to the rod 68. A stop cock 90 is secured to a distal end of the rod 68. When the cap 76 is secured to the reservoir 34, the post 70 biases into the end 86 of the lever 82, thereby forcing the opposite end 88 of the lever 82 up. In response, the rod 68 is forced up, thereby ensuring that the stop cock 90 is removed from the inlet 46.

When the cap 76 is removed, however, the post 70 no longer abuts into the lever 82. The weight of the rod 68 forces the end 88 of the lever 82 down, and the stop cock 90 moves into the inlet 46 and forms a water-tight seal. After filling, the cap 70 is re-secured, thereby biasing the lever 82 back into the position shown in FIG. 3, such that the stop cock 90 disengages from the inlet 46.

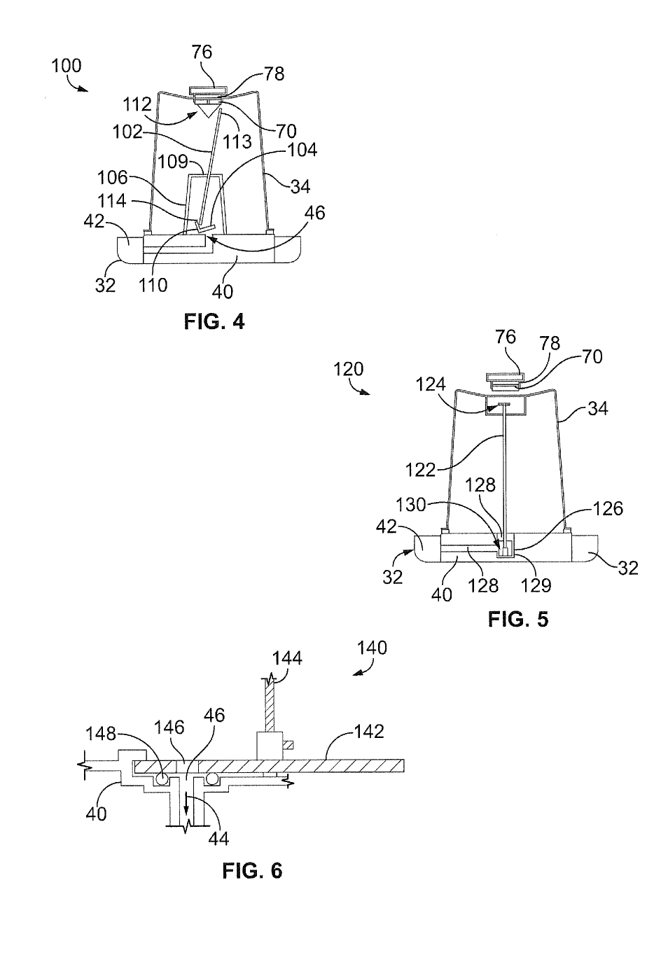

FIG. 4 illustrates a cross-sectional view of a watering system 100, according to an embodiment of the present invention. The watering system 100 is similar to the systems 30 and 80, except that the biasing mechanism includes an angled rod 102 movably secured to a pivoting sealing cover 104 above the inlet 46. The rod 102 is supported by a cage support 106 having upstanding beams 108 secured over the island 40. The beams 108 integrally connect to a ring 109. The rod 102 passes through the opening of the ring 109. A distal end of the rod 102 rests in a notch 110 formed in the right angle cover 104.

The cap 76 includes a downwardly-oriented cone 112 underneath the post 70. A proximal end 113 of the rod 102 abuts a base of the cone 112.

When the cap 76 is secured to the reservoir 34, the cone 112 forces the proximal end 113 of rod 102 away from a central axis of the reservoir 34. A distal end 114 of the rod 102 therefore moves away from the central axis in an opposite direction as the proximal end 113. The distal end 114 moves into an upstanding beam of the cover 104, thereby pivoting the cover 104 up. As such, the cover 104 moves off the inlet 46.

When the cap 76 is removed, the proximal end 113 of the rod 102 no longer contacts the cone 112. Then, the upstanding beam of the cover 104 exerts a force into the distal end 114 of the rod 104 forcing it to move back toward alignment with the central axis of the reservoir 34. In response, the cover 104 pivots down and sealingly covers the inlet 46. The distal end 114 of the rod 102 may be pivotally secured to the cover 104.

After filling, the cap 76 is secured to the reservoir 34, and the cone forces the rod 102 into the position shown in FIG. 4, in which the cover 104 moves away from the inlet 46.

FIG. 5 illustrates a cross-sectional view of a watering system 120, according to an embodiment of the present invention. The system 120 is similar to those described above, except that the cap 76 is secured to a rotatable rod 122. The rod 122 may include a tab 124 that is received and retained within a reciprocal slot or notch formed in the post 70 of the cap 76. When connected, rotation of the cap 76 causes the rod 122 to rotate.

A distal end of the rod 122 is connected to a rotatable plug 126 within the water path 128. The plug 126 includes an open top and a sealing side wall 129 that sealingly engages walls of the island 40 that define a portion of the water path 128. An opening 130 is formed through the side wall 129. In the operational position, the cap 76 is rotated so that the opening 130 is aligned with the water path 128. Thus, water may pass from the reservoir 34 into the water path 128, through the open top of the plug 126, then through the opening 130, and out into the trough 42. Before filling, the cap 76 is rotated so that the side wall 129 closes the opening to the trough 42.

In order to re-fill the reservoir, the cap 76 is rotated so that the opening to the trough 42 is blocked, as noted. The cap 76 is removed by simply lifting it upward so that it detaches from the tab 124 of the rod 122. Then, the reservoir 34 may be re-filled.

FIG. 6 illustrates a cross-sectional view of a selective water gate 140, according to an embodiment of the present invention. The gate 140 includes a flat disk 142 securely fastened to a rod 144. A hole 146 is formed through the disk 142 and is configured to rotatably align with the water inlet 46 of the island 40 (or any other portion where the water path 44 may be formed). The cap 76 (not shown) may be selectively rotated to position the hole 146 over the inlet 46, in order to allow water to pass into the inlet 46, and to rotate the hole 146 away from the inlet 46 so that disk material blocks water from passing into the inlet 46. A sealing O-ring 148 may be compressively sandwiched between the disk 142 and the island 40 around the inlet 46.

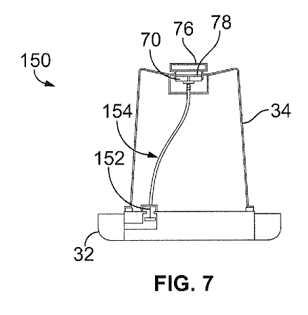

FIG. 7 illustrates a cross-sectional view of a watering system 150, according to an embodiment of the present invention. The system 150 is similar to the embodiments described above except that, instead of using a stiff rod, a flexible wire or rod 152 is positioned within a hollow tube 154. This configuration may be used in place of any of the rod configurations described and shown with respect to FIGS. 2-6.

Embodiments of the present invention may be used in conjunction with the heating system and method shown and described in U.S. application Ser. No. ______, filed Jan. 28, 2010, entitled “System and Method for Heating a Poultry Watering Device,” assigned to Allied Precision Industries Inc. (Attorney Docket No. 20494US02), which is hereby incorporated by reference in its entirety.

Thus, embodiments of the present invention provide a watering system and method that is configured to allow for quick and easy re-filling. As described, the water reservoir does not need to be removed and inverted in order to re-fill the reservoir.

Further, embodiments of the present invention provide a cost-effective design that does not include a double-walled reservoir construction.

While various spatial terms, such as upper, bottom, lower, mid, lateral, horizontal, vertical, and the like may be used to describe embodiments of the present invention, it is understood that such terms are merely used with respect to the orientations shown in the drawings. The orientations may be inverted, rotated, or otherwise changed, such that an upper portion is a lower portion, and vice versa, horizontal becomes vertical, and the like.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

1. A watering system configured to provide water to livestock, the system comprising:
a water basin defining a trough configured to retain water, wherein a water path having an inlet and outlet is formed through a portion of said water basin;
a reservoir mounted to said water basin;
a biasing mechanism configured to selectively open and close said inlet; and
a cap removably secured to said reservoir and configured to selectively engage said biasing mechanism to open and close said inlet, wherein said cap remains connected to said reservoir and said biasing mechanism when said inlet is open, and wherein said cap is configured to be removed in order to fill said reservoir.

2. The system of claim 1, wherein said reservoir comprises a top wall integrally connected to upstanding walls supported by said water basin, wherein said top wall is inwardly-canted, and wherein said cap is removably secured within an opening formed in said top wall.

3. The system of claim 1, wherein said cap comprises a seal that sealingly engages said reservoir.

4. The system of claim 1, wherein said biasing mechanism comprises a rod having first and second ends, wherein said first end abuts into a portion of said cap, and wherein said second end comprises a plug that is configured to sealingly seat into said inlet.

5. The system of claim 4, wherein said biasing mechanism further comprises a biasing spring around at least a portion of said rod, said biasing spring configured to be compressively sandwiched between said cap and a portion of said reservoir.

6. The system of claim 4, wherein said rod is flexible and contained within a tube.

7. The system of claim 1, wherein said biasing mechanism comprises a lever having first and second ends, wherein said first end is proximate said cap and said second end connects to a proximal end of a rod, and wherein a stop cock proximate said inlet is connected to a distal end of said rod.

8. The system of claim 1, wherein said cap comprises a cone, wherein said biasing mechanism comprises a rod movably secured within a cage support, and wherein a first end of said rod abuts said cone and a second end of said rod contacts a pivotal cover over said inlet.

9. The system of claim 1, wherein said biasing mechanism comprises a rotatable rod comprising a tab at a first end and a rotatable plug at a second end, wherein said rotatable plug is positioned within said water path, wherein said cap comprises a slot configured to receive and retain said tab, and wherein rotation of said cap causes a responsive rotation in said rotatable plug when said tab is retained within said slot.

10. The system of claim 9, wherein said rotatable plug comprises a side wall having an opening that is configured to be rotated into alignment with said outlet.

11. The system of claim 9, wherein said rotatable plug comprises a disk having an opening that is configured to be rotated into alignment with said outlet.

12. A method of re-filling a watering system configured to provide water to livestock, the method comprising:
disconnecting a cap positioned on a reservoir from a biasing mechanism that closes a water path within a water basin;
opening the water path through said disconnecting, wherein said opening comprises removing the biasing mechanism from a plugging relationship within the water path when the cap is disconnected from the biasing mechanism; and
opening a water intake of the reservoir through said disconnecting.

13. The method of claim 12, wherein said disconnecting comprises rotating the cap.

14. The method of claim 12, wherein said disconnecting comprises lifting the cap away from the reservoir.

15. The method of claim 12, wherein said opening the water path through said disconnecting comprises biasing a plug connected to a rod into a water inlet of the water path.

16. The method of claim 12, wherein said opening the water path through said disconnecting comprises removing a stop cock from an inlet of the water path through pivotal movement of a lever connected to a rod having the stop cock at a distal end.

17. The method of claim 12, wherein said opening the water path through said disconnecting comprises disconnecting a cone from a first end of a rod, wherein said disconnecting a cone causes a second end of the rod to move a cover over an inlet of the water path.

18. A system comprising:
a water basin defining a trough configured to retain water, wherein a water path having an inlet and outlet is formed through a portion of said water basin;
a reservoir formed of a single layer of material, wherein said reservoir is mounted to said water basin, wherein said reservoir comprises a top wall integrally connected to upstanding walls supported by said water basin, wherein said top wall is inwardly-canted, and wherein said cap is removably secured within an opening formed in said top wall;
a biasing mechanism configured to selectively open and close said inlet, wherein said biasing mechanism comprises a rod; and
a cap removably secured to said reservoir and configured to selectively engage said biasing mechanism to open and close said inlet, and wherein said cap remains connected to said reservoir and said biasing mechanism when said inlet is open wherein said cap comprises a seal that sealingly engages portions of said top wall that define said opening.

19. The system of claim 18, wherein said rod has first and second ends, wherein said first end abuts into a portion of said cap, and wherein said second end comprises a plug that is configured to sealingly seat into said inlet.

20. The system of claim 19, wherein said biasing mechanism further comprises a biasing spring around at least a portion of said rod, said biasing spring configured to be compressively sandwiched between said cap and a portion of said reservoir.

21. The system of claim 18, wherein said rod is flexible and contained within a tube.

22. The system of claim 18, wherein said biasing mechanism comprises a lever having first and second ends, wherein said first end is proximate said cap and said second end connects to a proximal end of said rod, and wherein a stop cock proximate said inlet is connected to a distal end of said rod.

23. The system of claim 18, wherein said cap comprises a cone, wherein said rod is movably secured within a cage support, and wherein a first end of said rod abuts said cone and a second end of said rod contacts a pivotal cover over said inlet.

24. The system of claim 18, wherein said rod comprises a tab at a first end and a rotatable plug at a second end, wherein said rotatable plug is positioned within said water path, wherein said cap comprises a slot configured to receive and retain said tab, and wherein rotation of said cap causes a responsive rotation in said rotatable plug when said tab is retained within said slot.

25. The system of claim 24, wherein said rotatable plug comprises a side wall having an opening that is configured to be rotated into alignment with said outlet.

26. The system of claim 24, wherein said rotatable plug comprises a disk having an opening that is configured to be rotated into alignment with said outlet.
